(19) United States
(12) Patent Application Publication
(10) Pub. No.: US 2009/0300485 A1
(43) Pub. Date: Dec. 3, 2009

(54) TECHNIQUES FOR AUTOMATICALLY GENERATING WIKI CONTENT

(75) Inventor: Bonnie N. Feinberg, Bellevue, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/127,018

(22) Filed: May 27, 2008

(51) Int. Cl. G06F 17/28

(52) U.S. Cl. 715/239

(57) ABSTRACT

Various technologies and techniques are disclosed for automatically generating Wiki content. Documentation files are transformed from a first markup language format to Wiki pages in a second markup language format utilized by a target Wiki. One or more style sheets are used to assist with the transforming from the first markup language format to the second markup language format. The Wiki pages are published to the target Wiki. A system for automatically generating Wiki content is also described. A transformation module is operable to transform documentation files into the Wiki pages. A publication database contains information related to the transformation of the documentation files into the Wiki pages. A publication module is operable to publish the Wiki pages to the target Wiki.

### BACKGROUND

Various types of documents get created by people every day. Some documents that get created are used for documenting how a given system or process operates, such as in the form of a user manual or operating guide. In many instances, the documentation that goes along with a product or service is also made available to customers who purchase the product or service. This documentation is usually created in one format, such as in a word processing program or web page editor. It may then be saved to another format that is better suited for access by end users, such as a PDF or other format.

With the rise of Internet technology, many companies have started to publish their documentation in online Wikis to enable customers to access this documentation. A Wiki is a collection of web pages that is typically designed to enable anyone who accesses it to contribute or modify content upon proper approval. Wiki pages use a simplified markup language, for which there are different dialects. Wikis are often used to create collaborative websites and to power community websites.

It can be difficult to integrate existing documentation systems with Wikis. Often the process is manual and involves many steps to convert documentation from one form (typically XML or HTML) to the format the Wiki understands. The conversion then leaves open the possibility that the Wiki pages will get out of sync with the original documents. Also, errors might be introduced during the conversion from one form to the other. Finally, manually managing many Wiki pages can be very time consuming as the content changes in the original documentation system.

### SUMMARY

Various technologies and techniques are disclosed for automatically generating Wiki content. Documentation files are transformed from a first markup language format to Wiki pages in a second markup language format utilized by a target Wiki. One or more style sheets are used to assist with the transforming from the first markup language format to the second markup language format. The Wiki pages are published to the target Wiki.

In one implementation, documentation files are first transformed into XHTML documents according to transformation metadata. Extra line breaks are removed from the XHTML documents. The XHTML documents are then transformed into Wiki pages.

In another implementation, a system for automatically generating Wiki content is also described. A transformation module is operable to transform documentation files into the Wiki pages. A publication database contains information related to the transformation of the documentation files into the Wiki pages. A publication module is operable to publish the Wiki pages to the target Wiki.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view of an automatic wiki content generation system of one implementation.

FIG. 2 is a process flow diagram for one implementation illustrating the stages involved in transforming documentation files into XHTML as an intermediate step, and then into Wiki pages.

FIG. 3 is a process flow diagram for one implementation illustrating the stages involved in automatically generating a table of contents for Wiki pages.

FIG. 4 is a simulated screen for one implementation that illustrates an example table of contents generated in a Wiki format.

FIG. 5 is a process flow diagram for one implementation illustrating the stages involved in publishing the Wiki pages generated from the transformation process to a target Wiki site.

FIG. 6 is a diagrammatic view for one implementation of a simplified Wiki publication schema.

FIG. 7 is a diagrammatic view for one implementation of a more advanced Wiki publication schema.

FIG. 8 is a diagrammatic view of a computer system of one implementation.

### DETAILED DESCRIPTION

The technologies and techniques herein may be described in the general context as an application that automatically generates Wiki content, but the technologies and techniques also serve other purposes in addition to these. In one implementation, one or more of the techniques described herein can be implemented as features within any type of program or service that manages multiple formats of the same documentation, and/or that is responsible for managing Wiki pages.

As noted in the background section, with the rise of Internet technology, many companies are starting to publish their documentation in online Wikis to enable customers to access this documentation. Wiki pages use a simplified markup language, for which there are different dialects. For example, lines of text are often started with an asterisk (“*”) to enter it in a bulleted list. The style and syntax of Wiki dialects (sometimes called Wikitexts) can vary greatly among Wiki implementations.

One issue can arise due to the fact that companies may have documentation written in one markup format, such as HTML, but then may also need to create and maintain Wiki pages for that same documentation so customers can access it. Since Wiki pages use their own dialect, maintaining two sets of the same documentation can be quite cumbersome. HTML, for example, has markup tags such as <BODY> and </BODY> that make it more programming oriented and less text friendly for reading the content. Wiki pages, on the other hand, use a markup language that is more focused on readability.

In one implementation, techniques are described for automatically converting existing documentation files into Wiki pages. The Wiki pages are then automatically published and updated over time so separate versions do not have to be maintained manually. In one implementation, tables of content are automatically generated to help locate specific Wiki pages of interest to the users of the Wiki. Mapping information is stored in one or more data stores or files to describe how the original documentation files map to the target Wiki system(s) on the Internet. This enables the Wiki pages to be kept in synchronization with the original documentation files over time.

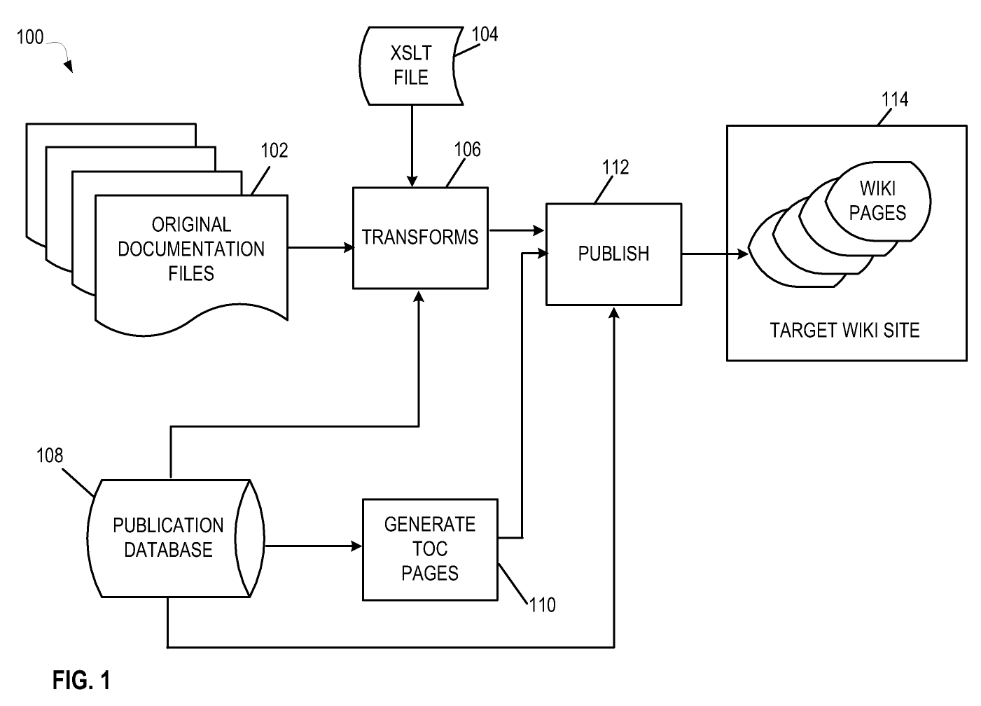

FIG. 1 is a diagrammatic view of an automatic wiki content generation system 100 of one implementation. Original documentation files 102 can be authored using one of various authoring tools. As a few non-limiting examples, the documentation files can be created using HTML, XML, XHTML, or other formats. Automated wiki content generation system 100 takes the set of documentation files 102 and transforms these files using an XSLT file 104 (or other transformation metadata) and a transformation component 106. The transformation component 106 uses information stored in a publication database 108 to drive the transformation process.

In one implementation, table of content pages are generated by a table of contents generation component 110 based on information in the publication database by the generation component. Wiki pages are generated as a result of applying the transformation component 106 and optional table of contents generation component 110. These pages are directed to the publication component 112 which automatically publishes the Wiki pages on a target Wiki site 114 which hosts the pages. The publication component 112 maps the original content to published Wiki pages based on the information contained in the publication database 108. Once the Wiki pages are generated along with any optional table of contents pages, then the publication component 112 is used to publish the Wiki pages to the target Wiki site 114. In one implementation, the process described herein can be repeated over time as changes are made to the original documentation files 102 to keep the target Wiki site 114 updated with the most recent version of the content.

A non-limiting example will now be described to illustrate how automatic Wiki content generation system 100 can be utilized in practice. Consider a customer who wishes to provide customers with access to code samples through a web site instead of on a CD or DVD in a boxed product. The documentation for the sample code is in an XML format and the individual HTM files generated from the documentation build have no intrinsic relationships. Wiki A can host the documentation, but Wiki A doesn't accept HTML files. Instead, Wiki A uses a particular dialect of a Wiki authoring language. Automatic Wiki content generation system 100 tracks the files which need to be converted, performs the conversion, automatically generates the table of contents Wiki pages so the individual pages can be found, and publishes all the pages automatically to Wiki A. Some of these techniques will now be discussed in further detail.

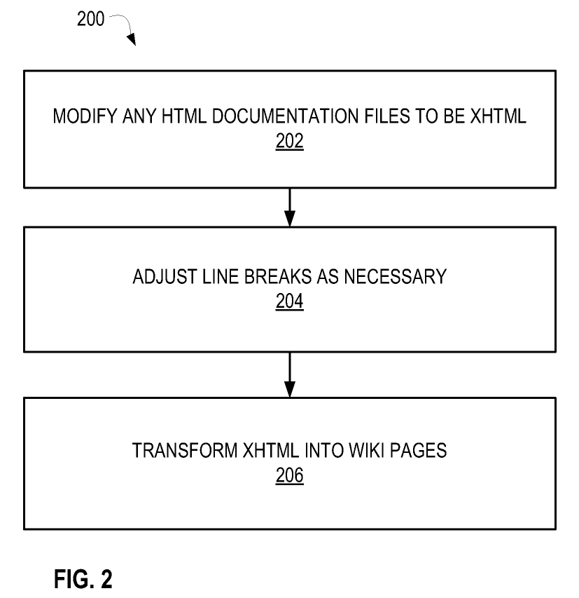

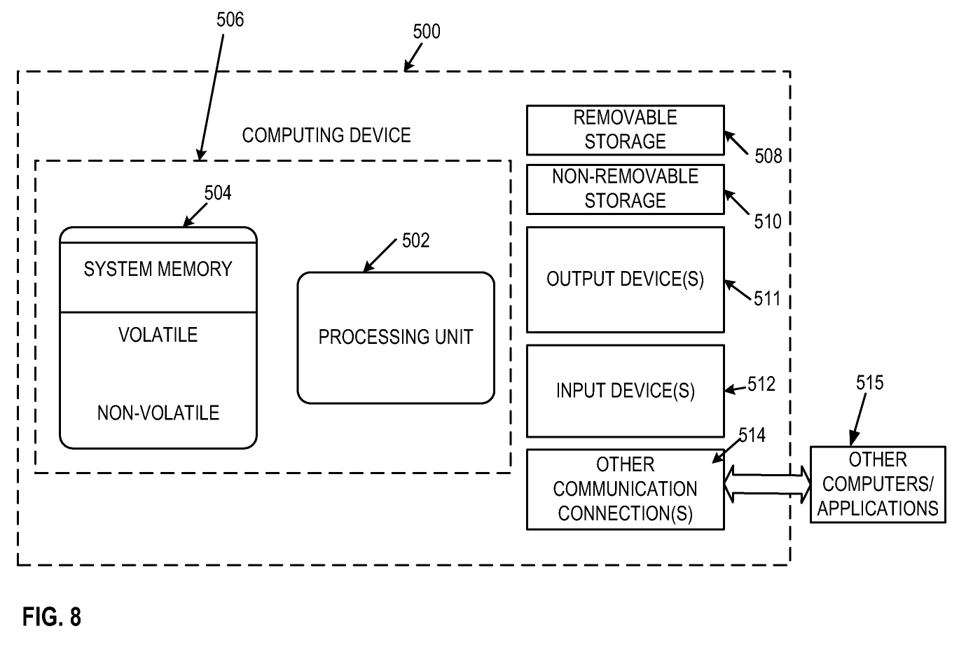

Turning now to FIGS. 2-7, the stages for implementing one or more implementations of automatic wiki content generation system 100 are described in further detail. In some implementations, the processes of FIG. 2-7 are at least partially implemented in the operating logic of computing device 500 (of FIG. 8).

FIG. 2 is a process flow diagram 200 for one implementation illustrating the stages involved in transforming documentation files into XHTML as an intermediate step, and then into Wiki pages. For any documentation files that are in an HTML format, the files are first converted to an XHTML format (stage 202). XHTML stands for Extensible Hypertext Markup Language, and is a markup language that has the same depth of expression as HTML, but also conforms to XML syntax. Whereas HTML is an application of Standard Generalized Markup Language (SGML), a very flexible markup language, XHTML is an application of XML, a more restrictive subset of SGML.

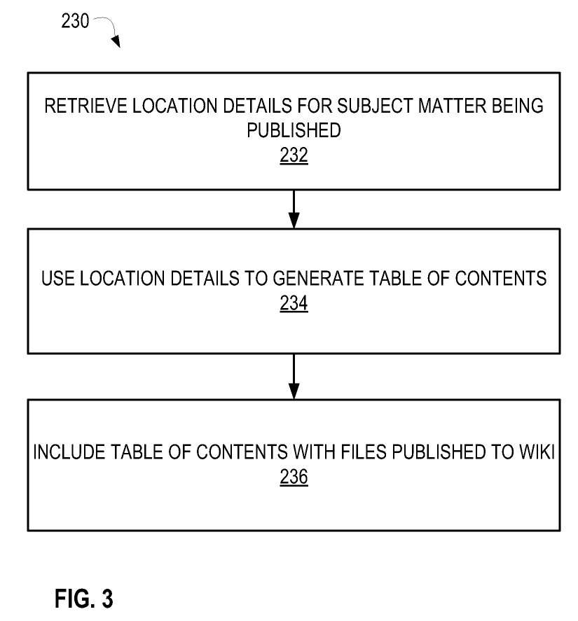

One reason for converting any HTML files into XHTML files is because HTML is not required to be well formed. HTML does not require closing tags, for example, and code such as <br> would be fine in HTML. However, such code is not considered well formed because it is difficult to see where the beginning and the end of the tag ends. XHTML, on the other hand, is a well formed markup language, and generally converts better to the even simpler Wiki formats. The HTML documentation files can be converted into XHTML using transformation metadata (such as an XSLT style sheet) and/or other logic. Once the HTML documentation files are converted into XHTML, then line breaks are adjusted as necessary (stage 204). One reason for adjusting the line breaks is because extra line breaks from the HTML files could end up becoming a new (blank) item in a list in the Wiki. Another reason is that extra line breaks could restart the numbering on enumerated lists, which can be undesirable. The XHTML files are then transformed into Wiki pages (stage 206). The transformation process is described in more detail in FIGS. 3-7.

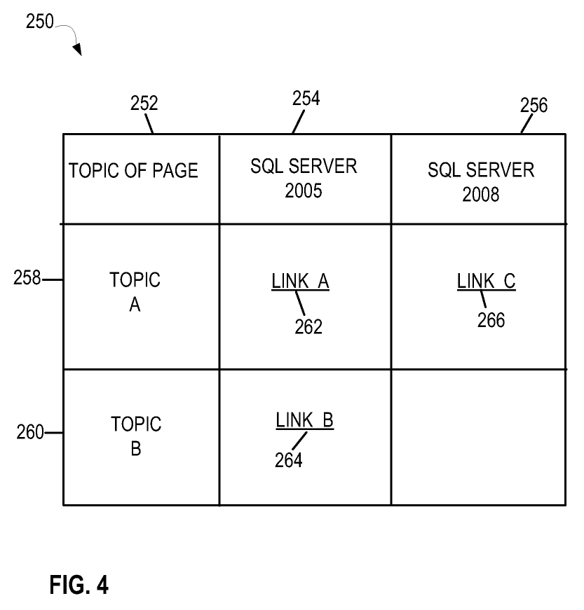

FIG. 3 is a process flow diagram 230 for one implementation illustrating the stages involved in automatically generating a table of contents for Wiki pages. Location details are retrieved for the subject matter being published (stage 232). Location details can include information about where in a given subject matter a particular topic fits in. Locations details are used to generate a table of contents (stage 234). The table of contents is then included with the files that are published to the target Wiki (stage 236). It should be noted that the generation of one or more tables of contents for Wiki pages is optional. In other words, in other implementations, table of contents are not generated at all. An example table of contents is shown in FIG. 4.

FIG. 4 is a simulated screen 250 for one implementation that illustrates an example table of contents generated in a Wiki format. The categories of the content in this example include SQL Server 2005 (254) and SQL Server 2008 (256). These are actually two different versions of the documentation being provided in a given Wiki. There are two topics (252), which are Topic A (258) and Topic B (260). The body of the table of contents contains hyperlinks (262, 264, and 266) for each topic to the respective version of the documentation.

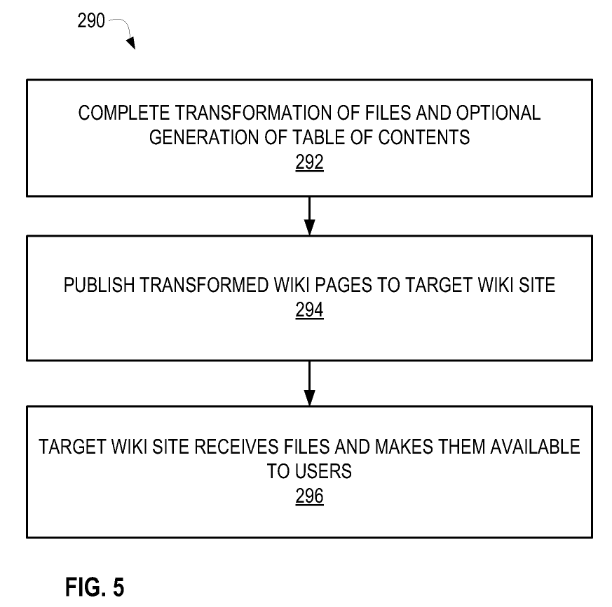

FIG. 5 is a process flow diagram 290 for one implementation illustrating the stages involved in publishing the Wiki pages generated from the transformation process to one or more target Wiki sites. Once the documentation files are transformed into Wiki pages and any optional table of contents Wiki pages are generated (stage 292), then the Wiki pages can be published to one or more target Wiki sites (stage 294). There are various ways for publishing the Wiki pages to the target Wiki site. For example, the files can be submitted through a web service, directly to a database on the target Wiki site, through FTP upload, and so on. Any approach for transmitting the Wiki pages to the target Wiki site or to a location accessible to the target Wiki site can be used. The target Wiki site receives the files and makes them available to users (stage 296).

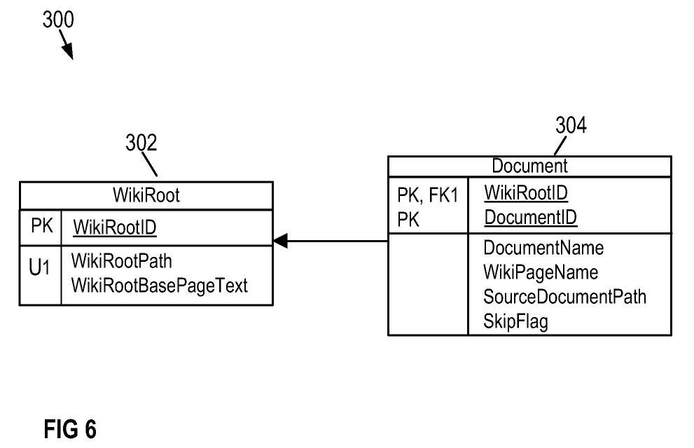

FIG. 6 is a diagrammatic view 300 for one implementation of a simplified Wiki publication schema which includes a WikiRoot table 302 and a Document table 304. Many different types of publication schemas could be used that include fewer or additional fields and/or tables than shown in FIG. 6. However, FIG. 6 is provided for the sake of illustration of how the techniques described herein can be utilized.

In one implementation, the WikiRoot table 302 keeps track of the location of the particular Wikis to which the automated Wiki generation system 100 publishes content. The WikiRootID is a primary key. The WikiRootPath is the URL to the Wiki. The WikiRootBasePageText is the Wiki content to publish on the root of the Wiki.

The Document table 304 keeps track of certain information about each document which is processed. The WikiRootID specifies the Wiki where the result of transforming this document is published. The DocumentID is the primary key which corresponds to the unique identity for this document. The DocumentName is the title of the document. The WikiPageName is the name of the Wiki page where it was published, if the page has been published. The SourceDocumentPath identifies where the original (untransformed) document is located. The SkipFlag, if set to true, indicates that the document should not be published to the Wiki at this time.

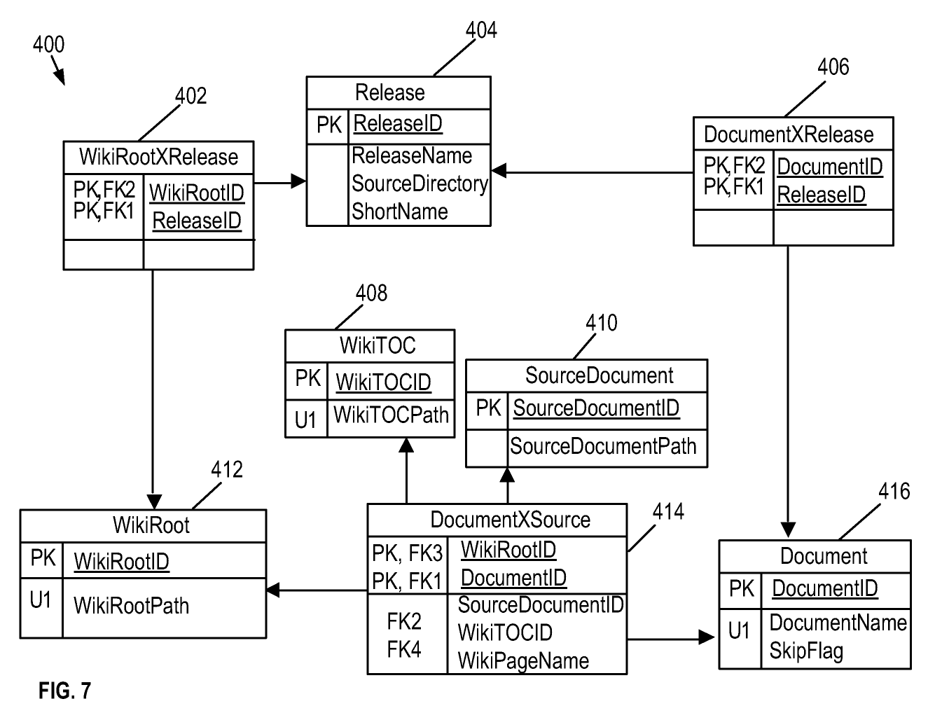

FIG. 7 is a diagrammatic view for one implementation of a more advanced Wiki publication schema. Just as with the more simplified schema shown in FIG. 6, the schema shown in FIG. 7 is also just for the sake of illustration. In other implementations, there could be fewer or additional fields and/or tables for implementing the techniques described herein.

The Release table 404 represents a particular version of a particular set of documentation. The ReleaseID is a primary key which uniquely identifies a particular version of a set of documentation. The ReleaseName is a human-understandable designation for the release. The Source Directory is the general location where the original documents are located. The ShortName is an abbreviation for the human-readable release name.

The WikiRootXRelease table 402 tracks which Wikis are involved in which versions of the documentation being processed. The WikiRootID contains the identity of the Wiki. The ReleaseID stores the release in which the Wiki participates.

The DocumentXRelease table 406 tracks which particular documents are involved in which versions of the documentation being processed. Even though a Wiki may participate in all releases, a document within the Wiki may participate in a subset of those. The DocumentID stores the identity of the document. The ReleaseID is a release in which the document participates.

The WikiTOC table 408 stores the design of the table of contents that will be generated for each Wiki root page. The WikiTOCID is the primary key which uniquely identifies a node in the table of contents. The WikiTOCPath is the human understandable name for the node in the TOC. If the TOC has multiple levels of hierarchy, names of each level of the hierarchy are separated by a well-known character, such as the forward slash (/) character.

The SourceDocument table 410 stores information about what the original source document is named. The SourceDocumentID is the primary key which uniquely identifies a location where a source document exists. The SourceDocumentPath contains additional location information (such as a file name) which when combined with the SourceDirectory information in the release provides an absolute location where the original document can be found. The original document might be a file system or database or some other kind of repository.

The WikiRoot table 412 keeps track of the location of the particular Wikis to which system 100 publishes content and other information that is useful about that Wiki. The WikiRootID is the key which uniquely identifies a particular Wiki. The WikiRootPath is the URL to the Wiki. The WikiRootBasePageText is the Wiki content to publish on the root of the Wiki along with the table of contents for that Wiki.

The DocumentXSource table 414 is used to relate information about where the document comes from, what the document is, and where it is published. The WikiRootID is the Wiki where this document should be published. The DocumentID indicates which document should be published. SourceDocumentID indicates where the original document is stored. The WikiTOCID indicates where in the table of contents this document's title should appear. The WikiPageName includes the name of the Wiki page where it was published, if this document has been published.

The Document table 416 is used to store document specific information and represent documents independently of where they come from and independently of where they are published. The DocumentID is the primary key which corresponds to the unique identity for this document. The DocumentName is the title of the document. The SkipFlag, if set to true, indicates that this document should not be published to any Wikis at this time.

Since the documentation published may cover more than version, the schema 400 shown in FIG. 7 captures the relationship between content and releases in the Release table 404, DocumentXRelease table 406, and Document table 416. The SourceDocument table 410 contains information on where the original source documents are located. The transformation component (106 on FIG. 1) uses this information to select the correct input files for transformation. The table of contents generation component (110 on FIG. 1) uses the WikiRoot table 412, WikiRootXRelease table 402, and the DocumentXSource table 414 to automatically generate appropriate table of contents. The publication component (112 on FIG. 1) uses the Document table 416, DocumentXRelease table 406, Release table 404, WikiRootXRelease table 402, WikiRoot table 412, and DocumentXSource table 414 tables to publish the results of the other components. The publication mechanism could use web services or browser automation to publish the pages to the Wiki, to name a few non-limiting examples.

As shown in FIG. 8, an exemplary computer system to use for implementing one or more parts of the system includes a computing device, such as computing device 500. In its most basic configuration, computing device 500 typically includes at least one processing unit 502 and memory 504. Depending on the exact configuration and type of computing device, memory 504 may be volatile (such as RAM), non-volatile (such as ROM, flash memory, etc.) or some combination of the two. This most basic configuration is illustrated in FIG. 8 by dashed line 506.

Additionally, device 500 may also have additional features/functionality. For example, device 500 may also include additional storage (removable and/or non-removable) including, but not limited to, magnetic or optical disks or tape. Such additional storage is illustrated in FIG. 8 by removable storage 508 and non-removable storage 510. Computer storage media includes volatile and nonvolatile, removable and non-removable media implemented in any method or technology for storage of information such as computer readable instructions, data structures, program modules or other data. Memory 504, removable storage 508 and non-removable storage 510 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 500. Any such computer storage media may be part of device 500.

Computing device 500 includes one or more communication connections 514 that allow computing device 500 to communicate with other computers/applications 515. Device 500 may also have input device(s) 512 such as keyboard, mouse, pen, voice input device, touch input device, etc. Output device(s) 511 such as a display, speakers, printer, etc. may also be included.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the examples discussed herein could be organized differently on one or more computers to include fewer or additional options or features than as portrayed in the examples.

What is claimed is:

1. A method for converting documents into a Wiki format comprising the steps of:
transforming documentation files into XHTML documents according to transformation metadata;
removing extra line breaks in the XHTML documents; and
transforming the XHTML documents into Wiki pages.

2. The method of claim 1, wherein the transformation metadata are included in a style sheet.

3. The method of claim 1, wherein at least some of the documentation files are in an HTML format.

4. The method of claim 1, wherein at least some of the documentation files are in an XML format.

5. The method of claim 1, wherein the Wiki pages are in a Wiki format supported by a target Wiki that the Wiki pages will be published to.

6. The method of claim 1, further comprising the steps of:
generating a table of contents for the Wiki pages.

7. The method of claim 1, further comprising the steps of:
publishing the Wiki pages to a target Wiki.

8. The method of claim 1, wherein all of the documentation files are written in a same source format.

9. A method for transforming documentation files into Wiki pages and publishing the Wiki pages comprising the steps of:
transforming documentation files from a first markup language format to Wiki pages in a second markup language format utilized by a target Wiki, using one or more style sheets to assist with the transforming from the first markup language format to the second markup language format; and
publishing the Wiki pages to the target Wiki.

10. The method of claim 9, wherein the Wiki pages are published to the target Wiki using a web service.

11. The method of claim 9, wherein the Wiki pages are published to the target Wiki by uploading the Wiki pages to a database utilized by the target Wiki.

12. The method of claim 9, wherein the Wiki pages are published to the target Wiki by a file transfer protocol upload process.

13. The method of claim 9, further comprising the steps of:
publishing a table of contents for the Wiki pages.

14. The method of claim 9, further comprising the steps of:
publishing background information regarding the target Wiki.

15. A system for automatically generating Wiki content comprising:
a transformation module that is operable to transform documentation files into Wiki pages;
a publication database that contains information related to the transformation of the documentation files into the Wiki pages; and
a publication module that is operable to publish the Wiki pages to a target Wiki.

16. The system of claim 15, further comprising:
a table of contents generation module that is operable to generate a table of contents for the Wiki pages.

17. The system of claim 16, wherein the table of contents generation module is operable to retrieve at least some information needed for the table of contents from the publication database.

18. The system of claim 15, wherein the publication database is operable to store details regarding the target Wiki to which the Wiki pages are published by the publication module.

19. The system of claim 15, wherein the transformation module is operable to convert the documentation files into XHTML files as an intermediate step, and then transforms the XHTML files into the Wiki pages.

20. The system of claim 15, wherein the transformation module is operable to utilize transformation metadata to assist with the transformation.
